(19) United States
(12) Patent Application Publication
(10) Pub. No.: US 2012/0127625 A1
(43) Pub. Date: May 24, 2012

(54) TRENCH CAPACITOR STRUCTURES AND METHOD OF MANUFACTURING THE SAME

(75) Inventors: Chung-Chih Wang, Taipei County (TW); Tzu-Kun Ku, Hsinchu City (TW); Cha-Hsin Lin, Tainan City (TW); Pei-Jer Tzeng, Hsinchu City (TW); Chi-Hon Ho, Tainan City (TW)

(73) Assignee: INDUSTRIAL TECHNOLOGY RESEARCH INSTITUTE, Hsinchu (TW)

(21) Appl. No.: 12/966,996

(22) Filed: Dec. 13, 2010

(30) Foreign Application Priority Data
Nov. 18, 2010 (TW) TW099139693

(51) Int. Cl. H01G 4/00; H01G 7/00

(52) U.S. Cl. 361/301.1; 29/25.41

(57) ABSTRACT

A trench capacitor structure is provided. The trench capacitor structure includes a substrate, a trench formed in the substrate, a plurality of scallops formed in the sidewalls of the trench, and at least one capacitor formed within at least one of the scallops. The disclosure also provides a method of manufacturing the trench capacitor structure.

### CROSS REFERENCE TO RELATED APPLICATIONS

This application claims priority of Taiwan Patent Application No. 99139693, filed on Nov. 18, 2010, the entirety of which is incorporated by reference herein.

### BACKGROUND

1. Technical Field

The disclosure relates to a trench capacitor structure, and in particular to a trench capacitor structure with scallops formed in sidewalls of a trench and a hemispherical grain structure and a manufacturing method thereof.

2. Technical Art

Recently, in electronics or semiconductor-related fields, in addition to process development trends, IC design trends also aim toward achieving the highest efficiency with the smallest area. With respect to parallel-plate capacitors, the simple computing formula of capacitance is

$$C = ɛ \frac{A}{d} = {ɛ}_{0} {ɛ}_{r} \frac{A}{d} ,$$

wherein ∈ is a dielectric coefficient (F/m), ∈₀=8.85×10⁻¹² (F/m) is a dielectric coefficient of vacuum, ∈ᵣ is a relative dielectric coefficient, A is an effective cross-section area (m²) of two parallel plates of a capacitor, and d is an effective distance (m) of two parallel plates of a capacitor. Currently, the number of different materials used to increase the relative dielectric coefficient (∈ᵣ) is limited. Also, shortening the effective distance (d) between two parallel plates is limited by corresponding processing technologies.

### SUMMARY

One embodiment of the disclosure provides a trench capacitor structure, comprising: a substrate; a trench formed in the substrate; a plurality of scallops formed in the sidewalls of the trench; and at least one capacitor formed within at least one of the scallops.

One embodiment of the disclosure provides a method of manufacturing a trench capacitor structure, comprising: providing a substrate; forming a trench with a plurality of scallops formed in the sidewalls thereof; and forming at least one capacitor within at least one of the scallops.

In the disclosure, a capacitor comprises a stacked conductive layer/dielectric layer/conductive layer or dielectric layer/conductive layer/dielectric layer/conductive layer is fabricated within a scallop structure which is simultaneously formed during formation of a trench by etching to increase surface area and capacitance thereof. Additionally, within the scallop structure, the conductive layer or the dielectric layer of the capacitor is fabricated into a hemispherical grain structure by several related methods, for example chemical vapor deposition (CVD) method, further improving surface area and capacitance per unit of area thereof. Additionally, when a plurality of capacitors are fabricated within the scallop structure, the capacitors form a parallel connection with one another through any proper electrical connection to improve capacitance thereof. Further, the electrode of the capacitor is formed from the directly drawn conductive layer from the front or back of the substrate.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawing, wherein:

FIGS. 1A and 1B show a trench capacitor structure and a manufacturing method thereof according to an embodiment of the disclosure;

FIG. 1B′ shows a trench capacitor structure and a manufacturing method thereof according to an embodiment of the disclosure;

FIG. 1C shows a trench capacitor structure and a manufacturing method thereof according to an embodiment of the disclosure;

FIG. 1C′ shows a trench capacitor structure and a manufacturing method thereof according to an embodiment of the disclosure;

FIG. 1D shows a trench capacitor structure and a manufacturing method thereof according to an embodiment of the disclosure;

FIG. 1D′ shows a trench capacitor structure and a manufacturing method thereof according to an embodiment of the disclosure;

FIG. 1E shows a trench capacitor structure and a manufacturing method thereof according to an embodiment of the disclosure;

FIG. 1E′ shows a trench capacitor structure and a manufacturing method thereof according to an embodiment of the disclosure;

FIG. 2A shows a trench capacitor structure and a manufacturing method thereof according to an embodiment of the disclosure;

FIG. 2A′ shows a trench capacitor structure and a manufacturing method thereof according to an embodiment of the disclosure;

FIG. 2B shows a parallel connection of a trench capacitor structure according to an embodiment of the disclosure;

FIG. 2B′ shows a parallel connection of a trench capacitor structure according to an embodiment of the disclosure;

FIG. 2C shows a trench capacitor structure and a manufacturing method thereof according to an embodiment of the disclosure;

FIG. 2C′ shows a trench capacitor structure and a manufacturing method thereof according to an embodiment of the disclosure;

FIG. 2D shows a trench capacitor structure and a manufacturing method thereof according to an embodiment of the disclosure;

FIG. 2D′ shows a trench capacitor structure and a manufacturing method thereof according to an embodiment of the disclosure;

FIG. 2E shows a parallel connection of a trench capacitor structure according to an embodiment of the disclosure;

FIG. 2E′ shows a parallel connection of a trench capacitor structure according to an embodiment of the disclosure;

FIG. 2F shows a trench capacitor structure and a manufacturing method thereof according to an embodiment of the disclosure; and

FIG. 2F′ shows a trench capacitor structure and a manufacturing method thereof according to an embodiment of the disclosure.

### DETAILED DESCRIPTION OF THE DISCLOSURE

The following description is of the best-contemplated mode of carrying out the disclosure. This description is made for the purpose of illustrating the general principles of the disclosure and should not be taken in a limiting sense. The scope of the disclosure is best determined by reference to the appended claims.

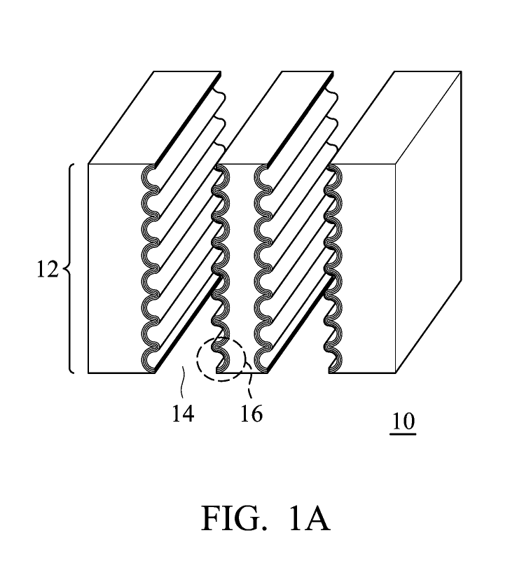

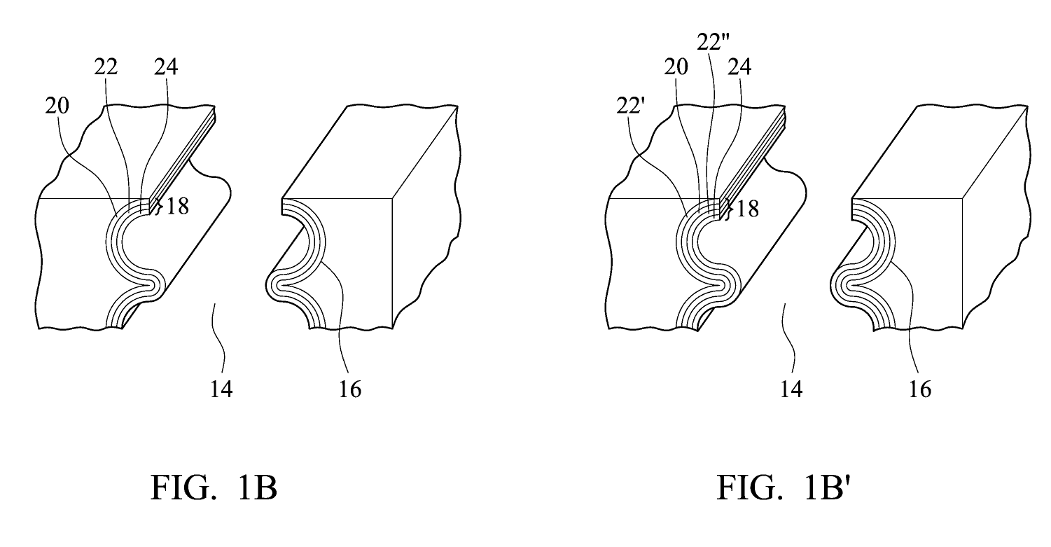

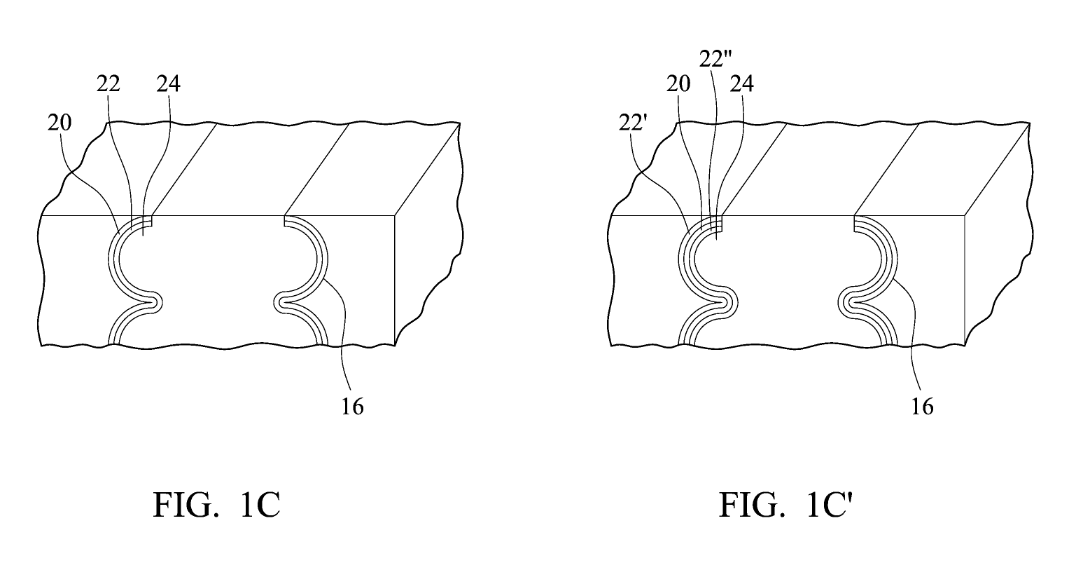

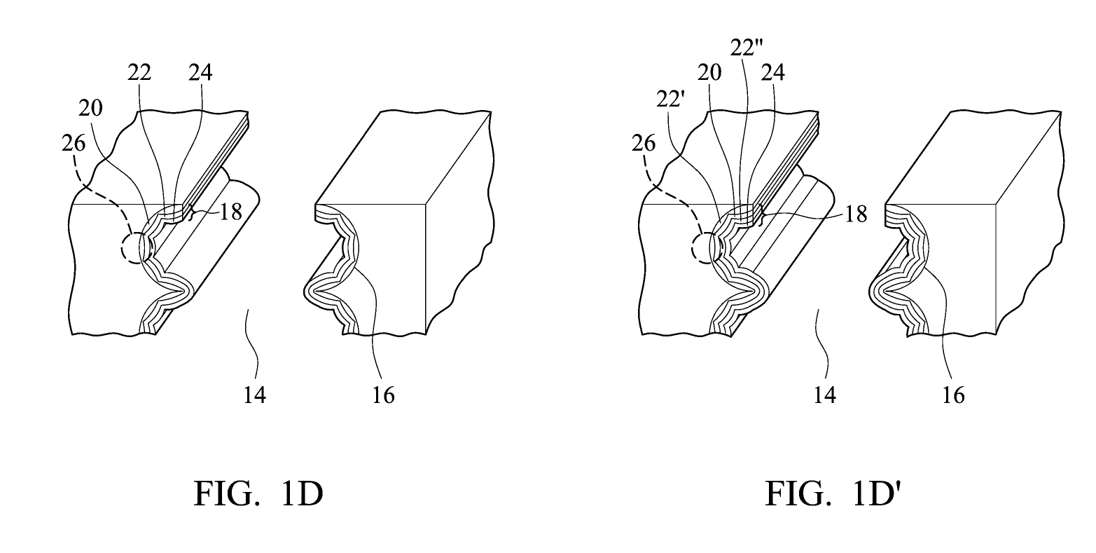

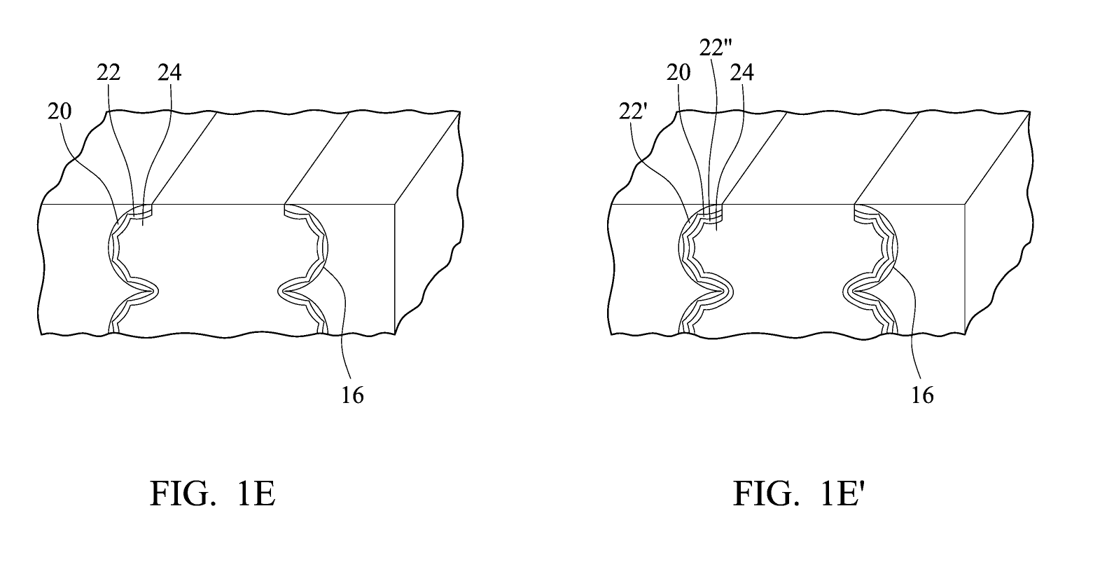

Referring to FIGS. 1A and 1B, in accordance with an embodiment of the disclosure, a trench capacitor structure is disclosed. Referring to FIG. 1A, the trench capacitor structure 10 comprises a substrate 12, a trench 14 formed in the substrate 12, a plurality of scallops 16 formed in the sidewalls of the trench 14, and at least one capacitor 18 formed within at least one of the scallops 16, as shown in FIG. 1B.

The substrate 12 may comprise a chip, a crystal grain, an interposer or a combination thereof. The interposer may connect a crystal grain or a chip to a printed circuit board. The interposer may comprise silicon.

The trench 14 may be a vertical trench or a non-vertical trench (not shown).

The scallops 16 formed in the sidewalls of the trench 14 may be continuous, as shown in FIG. 1B, or non-continuous (not shown).

Still referring to FIG. 1B, the capacitor 18 may comprise a first conductive layer 20 overlying the bottom of the scallop 16, a dielectric layer 22 overlying the first conductive layer 20 and a second conductive layer 24 overlying the dielectric layer 22. In an embodiment, the trench 14 may be filled with the second conductive layer 24 as an electrode of the capacitor 18, as shown in FIG. 1C. In an embodiment, the capacitor 18 may comprise a first dielectric layer 22′ overlying the bottom of the scallop 16, a first conductive layer 20 overlying the first dielectric layer 22′, a second dielectric layer 22″ overlying the first conductive layer 20 and a second conductive layer 24 overlying the second dielectric layer 22″, as shown in FIG. 1B′. In an embodiment, the trench 14 may be filled with the second conductive layer 24 as an electrode of the capacitor 18, as shown in FIG. 1C′.

In an embodiment, at least one of the first conductive layer 20, the dielectric layer 22 and the second conductive layer 24 may comprise hemispherical grains 26 or at least one hemispherical grain, as shown in FIG. 1D. In an embodiment, the trench 14 may be filled with the second conductive layer 24 as an electrode of the capacitor 18, as shown in FIG. 1E. In an embodiment, at least one of the first dielectric layer 22′, the first conductive layer 20, the second dielectric layer 22″ and the second conductive layer 24 may comprise hemispherical grains 26 or at least one hemispherical grain, as shown in FIG. 1D′. In an embodiment, the trench 14 may be filled with the second conductive layer 24 as an electrode of the capacitor 18, as shown in FIG. 1E′.

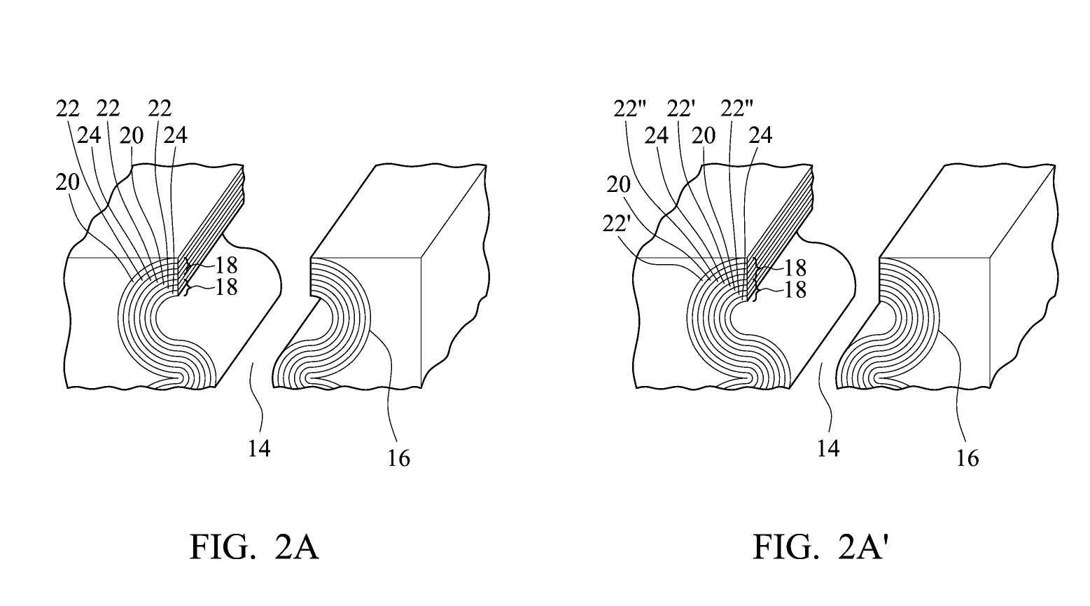

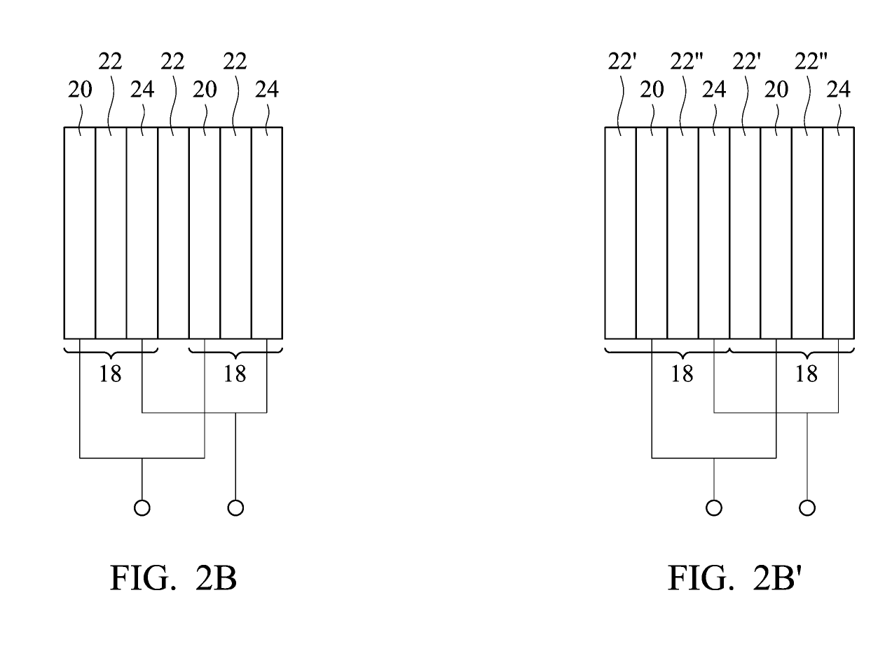

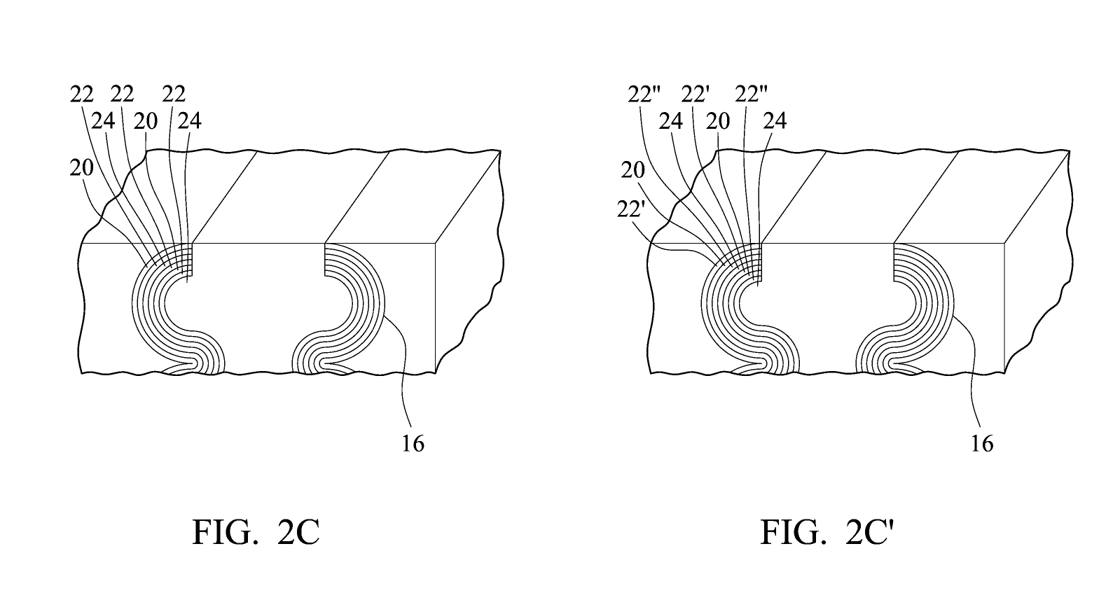

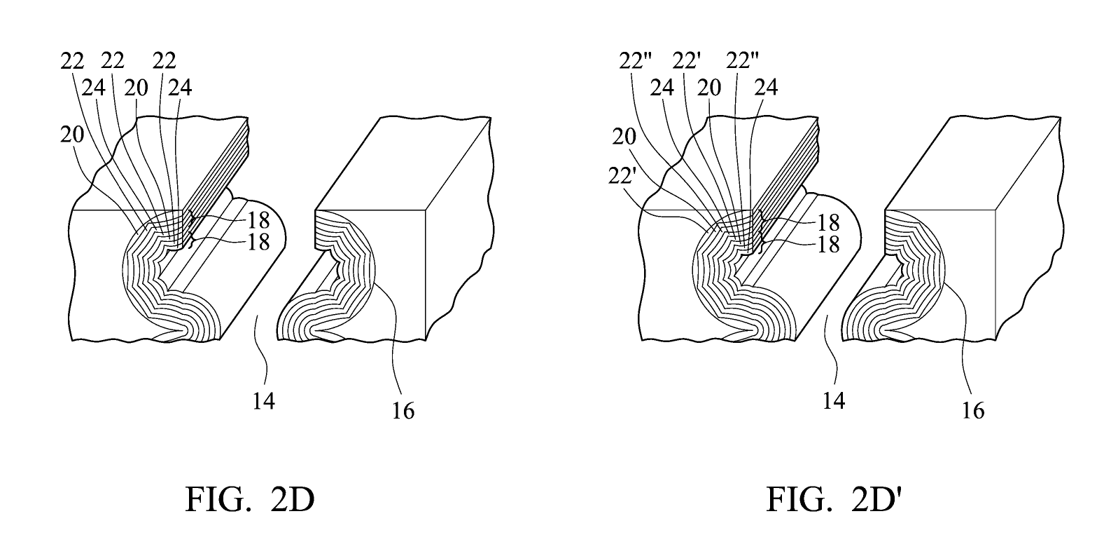

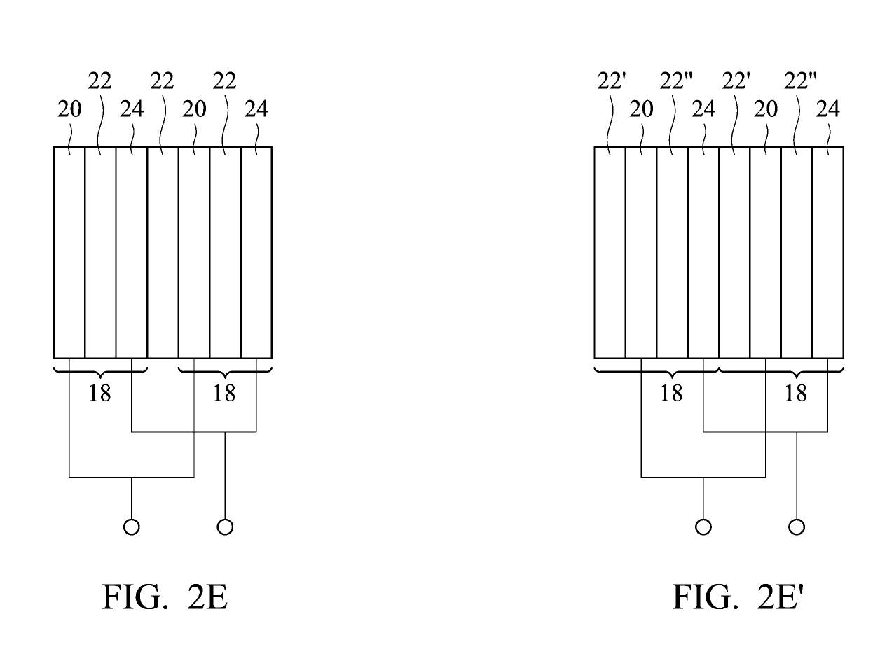

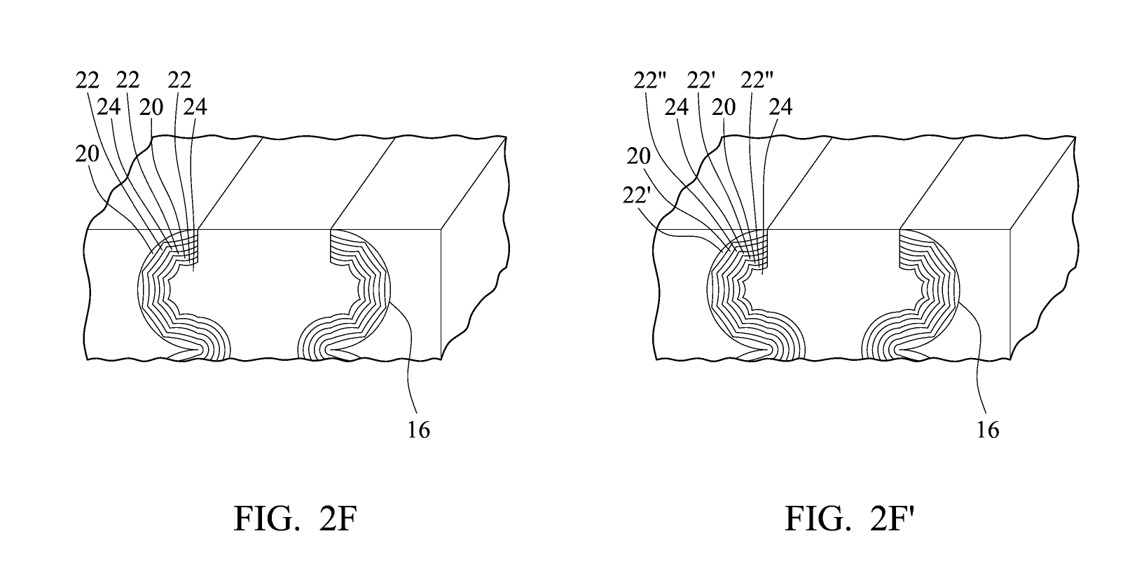

Referring to FIG. 2A, in an embodiment, when a plurality of capacitors 18 are formed within at least one of the scallops 16, the capacitors 18 may comprise a plurality of conductive layers and a plurality of dielectric layers 22 which are alternately arranged. In an embodiment, the capacitors 18 may be stacked and form a parallel connection with one another through any proper electrical connection, as shown in FIG. 2B. The conductive layers comprise a plurality of first conductive layers 20 and a plurality of second conductive layers 24. In an embodiment, the trench 14 may be filled with one of the conductive layers and the dielectric layers, for example the second conductive layer 24, as an electrode of the capacitor 18, as shown in FIG. 2C. In an embodiment, the capacitors 18 may comprise a plurality of conductive layers and a plurality of dielectric layers which are alternately arranged, as shown in FIG. 2A′. The conductive layers comprise a plurality of first conductive layers 20 and a plurality of second conductive layers 24. The dielectric layers comprise a plurality of first dielectric layers 22′ and a plurality of second dielectric layers 22″. In an embodiment, the capacitors 18 may be stacked and form a parallel connection with one another through any proper electrical connection, as shown in FIG. 2B′. In an embodiment, the trench 14 may be filled with one of the conductive layers and the dielectric layers, for example the second conductive layer 24, as an electrode of the capacitor 18, as shown in FIG. 2C′.

In an embodiment, at least one of the conductive layers and the dielectric layers 22 may comprise hemispherical grains or at least one hemispherical grain, as shown in FIG. 2D. The conductive layers comprise a plurality of first conductive layers 20 and a plurality of second conductive layers 24. In an embodiment, the capacitors 18 may be stacked and form a parallel connection with one another through any proper electrical connection, as shown in FIG. 2E. In an embodiment, the trench 14 may be filled with one of the conductive layers and the dielectric layers, for example the second conductive layer 24, as an electrode of the capacitor 18, as shown in FIG. 2F. In an embodiment, at least one of the conductive layers and the dielectric layers may comprise hemispherical grains or at least one hemispherical grain, as shown in FIG. 2D′. The conductive layers comprise a plurality of first conductive layers 20 and a plurality of second conductive layers 24. The dielectric layers comprise a plurality of first dielectric layers 22′ and a plurality of second dielectric layers 22″. In an embodiment, the capacitors 18 may be stacked and form a parallel connection with one another through any proper electrical connection, as shown in FIG. 2E′. In an embodiment, the trench 14 may be filled with one of the conductive layers and the dielectric layers, for example the second conductive layer 24, as an electrode of the capacitor 18, as shown in FIG. 2F′.

Still referring to FIGS. 1A and 1B, in accordance with an embodiment of the disclosure, a method of manufacturing a trench capacitor structure is disclosed. Referring to FIG. 1A, first, a substrate 12 is provided. Next, a trench 14 is formed in the substrate 12. Specifically, during formation of the trench 14 by etching, a plurality of scallops 16 are simultaneously formed in the sidewalls of the trench 14. Next, at least one capacitor 18 is formed within at least one of the scallops 16, as shown in FIG. 1B.

The substrate 12 may comprise a chip, a crystal grain, an interposer or a combination thereof. The interposer may connect a crystal grain or a chip to a printed circuit board. The interposer may comprise silicon.

In an embodiment, a vertical trench 14 may be formed in the substrate 12, as shown in FIG. 1B. In an embodiment, a non-vertical trench may be formed in the substrate (not shown).

Additionally, the scallops 16 formed in the sidewalls of the trench 14 may be continuous, as shown in FIG. 1B, or non-continuous (not shown).

The step of forming the capacitor 18 may comprise forming a first conductive layer 20 overlying the bottom of the scallop 16, forming a dielectric layer 22 overlying the first conductive layer 20 and forming a second conductive layer 24 overlying the dielectric layer 22, as shown in FIG. 1B. In an embodiment, the first conductive layer 20, the dielectric layer 22 and the second conductive layer 24 are formed by several related methods, for example deposition methods such as chemical vapor deposition (CVD) or oxidization methods. In an embodiment, the trench 14 may be filled with the second conductive layer 24 as an electrode of the capacitor 18, as shown in FIG. 1C. In an embodiment, the step of forming the capacitor 18 may comprise forming a first dielectric layer 22′ overlying the bottom of the scallop 16, forming a first conductive layer 20 overlying the first dielectric layer 22′, forming a second dielectric layer 22″ overlying the first conductive layer 20 and forming a second conductive layer 24 overlying the second dielectric layer 22″, as shown in FIG. 1B′. In an embodiment, the first dielectric layer 22′, the first conductive layer 20, the second dielectric layer 22″ and the second conductive layer 24 are formed by several related methods, for example deposition methods such as chemical vapor deposition (CVD) or oxidization methods. In an embodiment, the trench 14 may be filled with the second conductive layer 24 as an electrode of the capacitor 18, as shown in FIG. 1C′.

In an embodiment, at least one of the first conductive layer 20, the dielectric layer 22 and the second conductive layer 24 may be formed into hemispherical grains or at least one hemispherical grain therein by several related methods, for example deposition methods such as chemical vapor deposition (CVD) or oxidization methods, as shown in FIG. 1D. In an embodiment, the trench 14 may be filled with the second conductive layer 24 as an electrode of the capacitor 18, as shown in FIG. 1E. In an embodiment, at least one of the first dielectric layer 22′, the first conductive layer 20, the second dielectric layer 22″ and the second conductive layer 24 may be formed into hemispherical grains or at least one hemispherical grain therein by several related methods, for example deposition methods such as chemical vapor deposition (CVD) or oxidization methods, as shown in FIG. 1D′. In an embodiment, the trench 14 may be filled with the second conductive layer 24 as an electrode of the capacitor 18, as shown in FIG. 1E′.

Referring to FIG. 2A, in an embodiment, when a plurality of capacitors 18 are formed within at least one of the scallops 16, the capacitors 18 may be formed by several related methods, for example deposition methods such as chemical vapor deposition (CVD) or oxidization methods. The capacitor 18 comprises a plurality of conductive layers and a plurality of dielectric layers 22 which are alternately arranged. The conductive layers comprise a plurality of first conductive layers 20 and a plurality of second conductive layers 24. In an embodiment, the capacitors 18 may be stacked and form a parallel connection with one another through any proper electrical connection, as shown in FIG. 2B. In an embodiment, the trench 14 may be filled with one of the conductive layers and the dielectric layers, for example the second conductive layer 24, as an electrode of the capacitor 18, as shown in FIG. 2C. In an embodiment, the capacitors 18 may be formed by several related methods, for example deposition methods such as chemical vapor deposition (CVD) or oxidization methods. The capacitor 18 comprises a plurality of conductive layers and a plurality of dielectric layers which are alternately arranged, as shown in FIG. 2A′. The conductive layers comprise a plurality of first conductive layers 20 and a plurality of second conductive layers 24. The dielectric layers comprise a plurality of first dielectric layers 22′ and a plurality of second dielectric layers 22″. In an embodiment, the capacitors 18 may be stacked and form a parallel connection with one another through any proper electrical connection, as shown in FIG. 2B′. In an embodiment, the trench 14 may be filled with one of the conductive layers and the dielectric layers, for example the second conductive layer 24, as an electrode of the capacitor 18, as shown in FIG. 2C′.

In an embodiment, at least one of the conductive layers (comprising a plurality of first conductive layers 20 and a plurality of second conductive layers 24) and the dielectric layers 22 may be formed into hemispherical grains or at least one hemispherical grain therein by several related methods, for example deposition methods such as chemical vapor deposition (CVD) or oxidization methods, as shown in FIG. 2D. In an embodiment, the capacitors 18 may be stacked and form a parallel connection with one another through any proper electrical connection, as shown in FIG. 2E. In an embodiment, the trench 14 may be filled with one of the conductive layers and the dielectric layers, for example the second conductive layer 24, as an electrode of the capacitor 18, as shown in FIG. 2F. In an embodiment, at least one of the conductive layers and the dielectric layers may be formed into hemispherical grains or at least one hemispherical grain therein by several related methods, for example deposition methods such as chemical vapor deposition (CVD) or oxidization methods, as shown in FIG. 2D′. The conductive layers comprise a plurality of first conductive layers 20 and a plurality of second conductive layers 24. The dielectric layers comprise a plurality of first dielectric layers 22′ and a plurality of second dielectric layers 22″. In an embodiment, the capacitors 18 may be stacked and form a parallel connection with one another through any proper electrical connection, as shown in FIG. 2E′. In an embodiment, the trench 14 may be filled with one of the conductive layers and the dielectric layers, for example the second conductive layer 24, as an electrode of the capacitor 18, as shown in FIG. 2F′.

In the disclosure, a capacitor composed of a stacked conductive layer/dielectric layer/conductive layer or dielectric layer/conductive layer/dielectric layer/conductive layer is fabricated within a scallop structure which is simultaneously formed during formation of a trench by etching to increase surface area and capacitance thereof. Additionally, within the scallop structure, the conductive layer or the dielectric layer of the capacitor is fabricated into a hemispherical grain structure by several related methods, for example chemical vapor deposition (CVD) method, further improving surface area and capacitance per unit of area thereof. Additionally, when a plurality of capacitors are fabricated within the scallop structure, the capacitors form a parallel connection with one another through any proper electrical connection to improve capacitance thereof. Further, the electrode of the capacitor is formed from the directly drawn conductive layer from the front or back of the substrate.

While the disclosure has been described by way of example and in terms of preferred embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A trench capacitor structure, comprising:
a substrate;
a trench formed in the substrate;
a plurality of scallops formed in the sidewalls of the trench; and
at least one capacitor formed within at least one of the scallops.

2. The trench capacitor structure as claimed in claim 1, wherein the substrate comprises a chip, a crystal grain, an interposer or a combination thereof.

3. The trench capacitor structure as claimed in claim 2, wherein the interposer connects a crystal grain or a chip to a printed circuit board.

4. The trench capacitor structure as claimed in claim 1, wherein the trench is a vertical trench.

5. The trench capacitor structure as claimed in claim 1, wherein the trench is a non-vertical trench.

6. The trench capacitor structure as claimed in claim 1, wherein the capacitor comprises a first conductive layer overlying the bottom of the scallop, a dielectric layer overlying the first conductive layer and a second conductive layer overlying the dielectric layer.

7. The trench capacitor structure as claimed in claim 1, wherein the capacitor comprises a first dielectric layer overlying the bottom of the scallop, a first conductive layer overlying the first dielectric layer, a second dielectric layer overlying the first conductive layer and a second conductive layer overlying the second dielectric layer.

8. The trench capacitor structure as claimed in claim 6, wherein the trench is filled with the second conductive layer.

9. The trench capacitor structure as claimed in claim 7, wherein the trench is filled with the second conductive layer.

10. The trench capacitor structure as claimed in claim 6, wherein at least one of the first conductive layer, the dielectric layer and the second conductive layer comprises hemispherical grains or at least one hemispherical grain.

11. The trench capacitor structure as claimed in claim 7, wherein at least one of the first dielectric layer, the first conductive layer, the second dielectric layer and the second conductive layer comprises hemispherical grains or at least one hemispherical grain.

12. The trench capacitor structure as claimed in claim 10, wherein the trench is filled with the second conductive layer.

13. The trench capacitor structure as claimed in claim 11, wherein the trench is filled with the second conductive layer.

14. The trench capacitor structure as claimed in claim 1, wherein when a plurality of capacitors are formed within at least one of the scallops, the capacitor comprises a plurality of conductive layers and a plurality of dielectric layers which are alternately arranged.

15. The trench capacitor structure as claimed in claim 14, wherein the capacitors are stacked and form a parallel connection with one another through a proper electrical connection.

16. The trench capacitor structure as claimed in claim 14, wherein the trench is filled with one of the conductive layer and the dielectric layer.

17. The trench capacitor structure as claimed in claim 14, wherein at least one of the conductive layer and the dielectric layer comprises hemispherical grains or at least one hemispherical grain.

18. The trench capacitor structure as claimed in claim 17, wherein the capacitors are stacked and form a parallel connection with one another through a proper electrical connection.

19. The trench capacitor structure as claimed in claim 17, wherein the trench is filled with one of the conductive layer and the dielectric layer.

20. A method of manufacturing a trench capacitor structure, comprising:
providing a substrate;
forming a trench with a plurality of scallops formed in the sidewalls thereof; and
forming at least one capacitor within at least one of the scallops.

21. The method of manufacturing a trench capacitor structure as claimed in claim 20, wherein the substrate comprises a chip, a crystal grain, an interposer or a combination thereof.

22. The method of manufacturing a trench capacitor structure as claimed in claim 21, wherein the interposer connects a crystal grain or a chip to a printed circuit board.

23. The method of manufacturing a trench capacitor structure as claimed in claim 20, wherein the trench is a vertical trench.

24. The method of manufacturing a trench capacitor structure as claimed in claim 20, wherein the trench is a non-vertical trench.

25. The method of manufacturing a trench capacitor structure as claimed in claim 20, wherein the step of forming the capacitor comprises forming a first conductive layer overlying the bottom of the scallop, forming a dielectric layer overlying the first conductive layer and forming a second conductive layer overlying the dielectric layer.

26. The method of manufacturing a trench capacitor structure as claimed in claim 20, wherein the step of forming the capacitor comprises forming a first dielectric layer overlying the bottom of the scallop, forming a first conductive layer overlying the first dielectric layer, forming a second dielectric layer overlying the first conductive layer and forming a second conductive layer overlying the second dielectric layer.

27. The method of manufacturing a trench capacitor structure as claimed in claim 25, wherein the first conductive layer, the dielectric layer and the second conductive layer are formed by deposition or oxidization methods.

28. The method of manufacturing a trench capacitor structure as claimed in claim 26, wherein the first dielectric layer, the first conductive layer, the second dielectric layer and the second conductive layer are formed by deposition or oxidization methods.

29. The method of manufacturing a trench capacitor structure as claimed in claim 25, wherein the trench is filled with the second conductive layer.

30. The method of manufacturing a trench capacitor structure as claimed in claim 26, wherein the trench is filled with the second conductive layer.

31. The method of manufacturing a trench capacitor structure as claimed in claim 25, wherein at least one of the first conductive layer, the dielectric layer and the second conductive layer is formed into hemispherical grains or at least one hemispherical grain therein by deposition or oxidization methods.

32. The method of manufacturing a trench capacitor structure as claimed in claim 26, wherein at least one of the first dielectric layer, the first conductive layer, the second dielectric layer and the second conductive layer is formed into hemispherical grains or at least one hemispherical grain therein by deposition or oxidization methods.

33. The method of manufacturing a trench capacitor structure as claimed in claim 31, wherein the trench is filled with the second conductive layer.

34. The method of manufacturing a trench capacitor structure as claimed in claim 32, wherein the trench is filled with the second conductive layer.

35. The method of manufacturing a trench capacitor structure as claimed in claim 20, wherein when a plurality of capacitors are formed within at least one of the scallops, a plurality of conductive layers and a plurality of dielectric layers of the capacitors are formed by deposition or oxidization methods, and the conductive layers and the dielectric layers are alternately arranged.

36. The method of manufacturing a trench capacitor structure as claimed in claim 35, wherein the capacitors are stacked and form a parallel connection with one another through a proper electrical connection.

37. The method of manufacturing a trench capacitor structure as claimed in claim 35, wherein the trench is filled with one of the conductive layers and the dielectric layers.

38. The method of manufacturing a trench capacitor structure as claimed in claim 35, wherein at least one of the conductive layers and the dielectric layers are formed into hemispherical grains or at least one hemispherical grain therein by deposition or oxidization methods.

39. The method of manufacturing a trench capacitor structure as claimed in claim 38, wherein the capacitors are stacked and form a parallel connection with one another through a proper electrical connection.

40. The method of manufacturing a trench capacitor structure as claimed in claim 38, wherein the trench is filled with one of the conductive layers and the dielectric layers.
